(19) United States
(12) Patent Application Publication
(10) Pub. No.: US 2015/0277142 A1
(43) Pub. Date: Oct. 1, 2015

(54) EYEWEAR RETENTION SYSTEM WITH ATTACHING DEVICE AND METHOD OF USE

(71) Applicant: Carolanne Olsen, Brandon, FL (US)

(72) Inventor: Carolanne Olsen, Brandon, FL (US)

(21) Appl. No.: 14/611,305

(22) Filed: Feb. 2, 2015

Related U.S. Application Data
(60) Provisional application No. 61/935,538, filed on Feb. 4, 2014.

(51) Int. Cl. G02C 3/00

(52) U.S. Cl. CPC G02C 3/006

(57) ABSTRACT

The present invention employs several unique innovations wherein the eyewear retention system includes an attaching device that enables the user to place the eyewear and eyewear retention system around the user's face, head, or neck and connect the attaching device on the eyewear retention system in front of or behind the user's face, head, or neck.

### CROSS-REFERENCE TO RELATED APPLICATIONS

This application claims the benefit of U.S. Provisional Application No. 61/935,538, filed Feb. 4, 2014, which is hereby incorporated by reference in its entirety for all purposes.

### BACKGROUND OF THE INVENTION

1. Field of the Invention

The presently disclosed subject matter relates to eyewear accessories. More particularly, the present invention relates to eyewear retention devices and/or systems.

2. Description of the Prior Art

For many years there have been eyewear retention devices, such as eyewear leashes, cords, among others. In most cases, eyewear retention devices are usually placed around the user's neck by connecting said eyewear retention device to a piece of eyewear and then sliding both the eyewear retention device and piece of eyewear over the user's head.

The present invention employs several unique innovations wherein the eyewear retention system includes an attaching device that enables the user to place the eyewear and eyewear retention system around the user's face, head, or neck and connect the attaching device on the eyewear retention system in front of or behind the user's face, head, or neck.

### SUMMARY OF THE INVENTION

Briefly described, embodiments of the presently disclosed subject matter relate to an eyewear retention system with attaching. The present invention may include at least two straps or panels with each of the at least two straps or panels having a first end and second end and the first end and/or second end of each of the at least two straps or panels having at least one attaching device. At least one of the at least one attaching device on each of the at least two straps or panels may be at least one of a complete quick snap attaching device, the male portion of a quick snap attaching device, and/or the female portion of a quick snap attaching device. At least one of the at least one attaching device may be at least one connection tube. At least one of the at least two straps or panels may be elongated. The at least one connection tube may be elongated. The at least two straps or panels may be fabricated in part or in whole from at least one of plastic, fabric, rubber, elastic, nylon, metal, hemp, animal skin and/or natural and/or synthetic rubber-like material. The at least one connection tube may have a first end and second end. The first end and/or second end of the at least one connection tube can connect and/or attach to the first end and/or second end of at least one of the at least two straps or panels. The first end and/or second end of the at least one connection tube can connect and/or attach to a piece of eyewear. Each of the at least one attaching device may be fabricated in part or in whole from at least one of plastic, fabric, rubber, elastic, nylon, metal, hemp, animal skin and/or natural and/or synthetic rubber-like material. The eyewear retention system with attaching device can retain eyewear to the head, neck, or other body part of the wearer at a desired level of retention.

The method for use of the eyewear retention system with attaching device may include four scenarios. In the first scenario of the method of use (i) one of the attaching devices one of the attaching devices on one of the at least two straps or panels is a male portion of the quick snap attaching device, and one of the attaching devices on the other one of the at least two straps or panels is a female portion of the quick snap attaching device; (ii) said male portion of the quick snap attaching device and female portion of the quick snap attaching device of the eyewear retention system with attaching device are not attached or connected together prior to User's use; and (iii) User does not desire to connect said male portion of the quick snap attaching device and female portion of the quick snap attaching device prior to placing the eyewear retention system with attaching device around the User. The first scenario of the method of use may comprise the following steps: User may take control of a piece of eyewear, such as eyeglasses or sunglasses; User may take control of the earpieces of said piece of eyewear; User may unfold and/or extend the earpieces of said piece of eyewear; User may takes control of one of the connection tubes of the eyewear retention system with attaching device and takes control of one earpiece of said piece of eyewear; User may slide said earpiece into said connection tube; User may take control of the other connection tube of the eyewear retention system with attaching device and takes control of the other earpiece of said piece of eyewear; User may slide said earpiece into said connection tube; User may place said piece of eyewear in front of User's face and/or neck; User may place one of the at least two straps or panels on one side of the User's face, head, and/or neck; User may place the other one of the at least two straps or panels on the other side of the User's face, head, and/or neck; and User may connect the male portion of the quick snap attaching device and the female portion of the quick snap attaching device together behind User's neck/head.

In the second scenario of the method of use (i) one of the attaching devices on one of the at least two straps or panels is a male portion of the quick snap attaching device, and one of the attaching devices on the other one of the at least two straps or panels is a female portion of the quick snap attaching device; (ii) said male portion of the quick snap attaching device and female portion of the quick snap attaching device of the eyewear retention system with attaching device are not attached or connected together prior to User's use; and (iii) User desires to have said male portion of the quick snap attaching device and female portion of the quick snap attaching device connected prior to the eyewear retention system and attaching device around the User. The second scenario of the method of use may comprise the following steps: User may take control of a piece of eyewear, such as eyeglasses or sunglasses; User may take control of the earpieces of said piece of eyewear; User may unfold and/or extend the earpieces of said piece of eyewear; User may take control of one of the connection tubes of the eyewear retention system with attaching device and takes control of one earpiece of said piece of eyewear; User may slide said earpiece into said connection tube; User may take control of the other connection tube of the eyewear retention system with attaching device and takes control of the other earpiece said piece of eyewear; User may slide said earpiece into said connection tube; User may take control of the male portion of the quick snap attaching device and the female portion of the quick snap attaching device; User may attach and/or connect the male portion of the quick snap attaching device and the female portion of the quick snap attaching device together; and User may place said piece of eyewear and the eyewear retention system with attaching device over User's head in a manner that allows User's head to slide through the space created between said piece of eyewear and the eyewear retention system with attaching device.

In the third scenario of the method of use (i) one of the attaching devices on one of the at least two straps or panels is a male portion of the quick snap attaching device, and one of the attaching devices on the other one of the at least two straps or panels is a female portion of the quick snap attaching device; (ii) said male portion of the quick snap attaching device and female portion of the quick snap attaching device of the eyewear retention system with attaching device are attached or connected together prior to User's use; and (iii) User does not desire to connect said male portion of the quick snap attaching device and female portion of the quick snap attaching device prior to placing the eyewear retention system with attaching device around the User. The third scenario of the method of use may comprise the following steps: User may take control of a piece of a piece eyewear, such as eyeglasses or sunglasses; User may take control of the earpieces of said piece of eyewear; User may unfold and/or extend the earpieces of said piece of eyewear; User may take control of one of the connection tubes of the eyewear retention system with attaching device and takes control of one earpiece of said piece of eyewear; User may slide said earpiece into said connection tube; User may take control of the other connection tube of the eyewear retention system with attaching device and takes control of the other earpiece of said piece of eyewear; User may slide said earpiece into said connection tube; User may take control of the male portion of the quick snap attaching device and the female portion of the quick snap attaching device; User may disconnect the male portion of the quick snap attaching device from the female portion of the quick snap attaching device; User may place said piece of eyewear in front of the User's face and/or neck; User may place one of the at least two straps or panels on one side of the User's face, head, and/or neck; User may place the other one of the at least two straps or panels on the other side of the User's face, head, and/or neck; and User may connect the male portion of the quick snap attaching device and the female portion of the quick snap attaching device together behind User's neck/head.

In the fourth scenario of the method of use (i) one of the attaching devices on one of the at least two straps or panels is a male portion of the quick snap attaching device, and one of the attaching devices on the other one of the at least two straps or panels is a female portion of the quick snap attaching device; (ii) said male portion of the quick snap attaching device and female portion of the quick snap attaching device of the eyewear retention system with attaching device are attached or connected together prior to User's use; and (iii) User desires to have said male portion of the quick snap attaching device and female portion of the quick snap attaching device connected prior to the eyewear retention system and attaching device around the User. The fourth scenario of the method of use may comprise the following steps: User may take control of a piece of eyewear, such as eyeglasses or sunglasses; User may take control of the earpieces of said piece of eyewear; User may unfold and/or extend the earpieces of said piece of eyewear; User may take control of one of the connection tubes of the eyewear retention system with attaching device and takes control of one earpiece of said piece of eyewear; User may slide said earpiece into said connection tube; User may take control of the other connection tube of the eyewear retention system with attaching device and takes control of the other earpiece of said piece of eyewear; and User may place the eyewear and eyewear retention system with attaching device over User's head in a manner that allows User's head to slide through the space created between the eyewear and the eyewear retention system with attaching device.

Although preferred embodiments of the present invention have been described, it will be understood by those skilled in the art that the present invention should not be limited to the described preferred embodiments. Rather, various changes and modifications can be made with within the spirit and scope of the present invention.

### BRIEF DESCRIPTION OF THE SEVERAL VIEWS OF THE DRAWING

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 depicts one embodiment of the present invention that is connected to a piece of eyewear and has an attaching device in the form of a side release buckle that is in an open, unattached position.

FIG. 2 depicts one embodiment of the present invention that is connected to a piece of eyewear and has an attaching device in the form of a side release buckle that is in a closed, attached position.

### DETAILED DESCRIPTION OF THE INVENTION

Detailed descriptions of particular embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

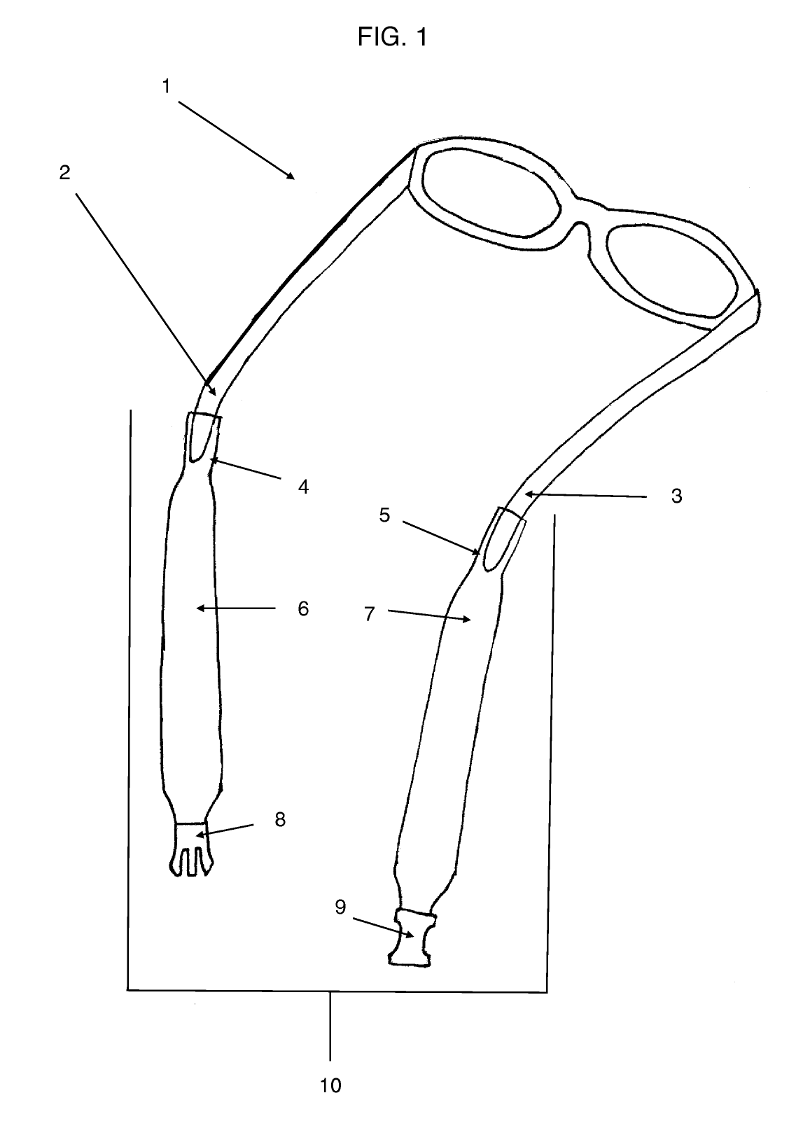

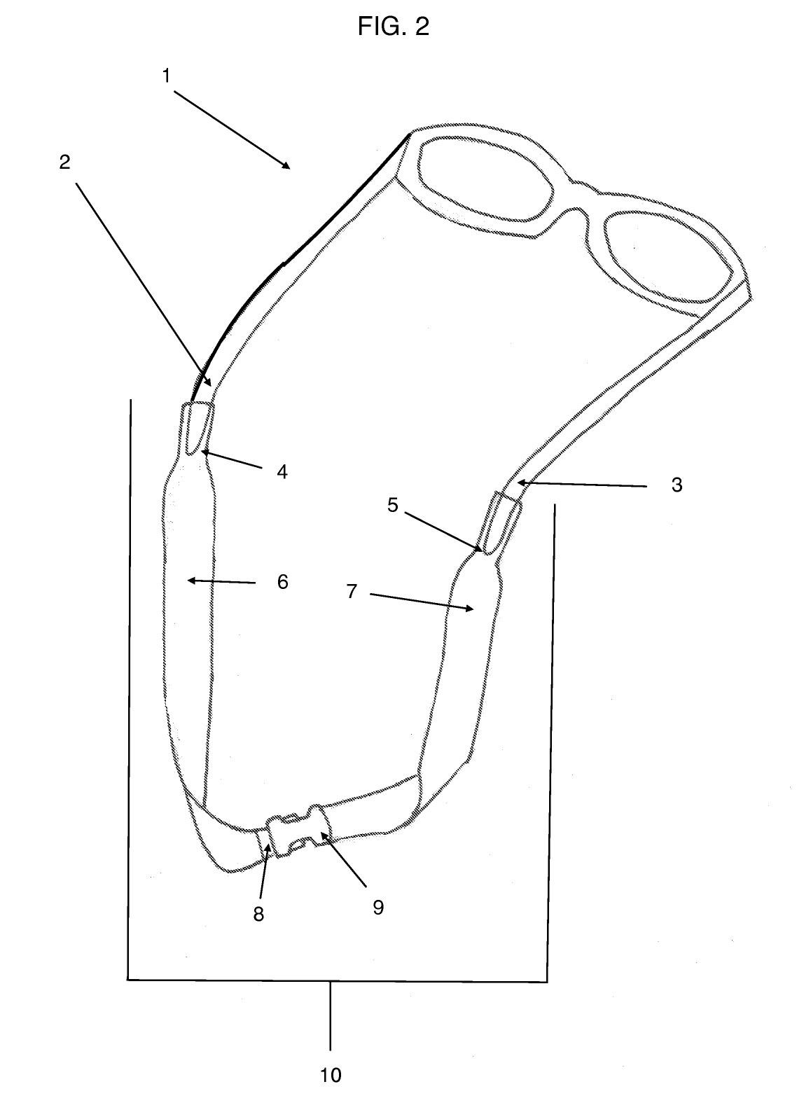

FIGS. 1 and 2 depict one embodiment of the present invention in which the eyewear retention system and attachment device 10 is attached and/or connected to a piece of eyewear 1. In this embodiment of the present invention the eyewear retention system and attachment device 10 comprises a first connection tube 4, a second connection tube 5, a first strap 6, a second strap 7, and an attachment device, which comprises a male portion of a side release buckle 8, and a female portion of a side release buckle 9. The first temple 2 of a piece of eyewear 1 attaches and/or connects to the eyewear retention system and attachment device 10 by sliding, connecting and/or attaching said first temple 2 into the first connection tube 4, which is attached to an end of the first strap 6. The other end of the first strap 6 has a portion of the attachment device, namely the male portion of a side release buckle 8. The second temple 3 of a piece of eyewear 1 attaches and/or connects to the eyewear retention system and attachment device 10 by sliding, connecting and/or attaching said second temple 3 into the second connection tube 5, which is attached to an end of the second strap 7. The other end of the second strap 7 has a portion of the attachment device, namely the female portion of a buckle 9. In FIG. 1 the attachment device is in an open, unattached position as the male portion of the buckle 8 and the female portion of the buckle 9 are not connected and/or attached to one another. FIG. 2 shows the attachment device in a closed, attached position as the male portion of the buckle 8 and the female portion of the buckle 9 are connected and/or attached to one another.

Although preferred embodiments of the present invention have been described it will be understood by those skilled in the art that the present invention should not be limited to the described preferred embodiments. Rather, various changes and modifications can be made within the spirit and scope of the present invention.

### COMPONENT LIST FOR DRAWINGS

Following is a partial list of the components depicted in the drawings:

| Component Number | Component Description |
|---|---|
| 1 | Eyewear |
| 2 | First Earpiece |
| 3 | Second Earpiece |
| 4 | First Connection Tube |
| 5 | Second Connection Tube |
| 6 | First Strap |
| 7 | Second Strap |
| 8 | Male Portion of Side Release Buckle |
| 9 | Female Portion of Side Release Buckle |
| 10 | Eyewear Retention System and Attaching |
| | Device |

### DEFINITIONS

As used herein, the term “and/or,” when used in a list of two or more items, means that any one of the listed items can be employed by itself, or any combination of two or more of the listed items can be employed. For example, if a device is described as containing components A, B, and/or C, the composition can contain A alone; B alone; C alone; A and B in combination; A and C in combination; B and C in combination; or A, B, and C in combination.

As used herein, the term “straps” and “panels” means strips or thongs of flexible material used for retaining, securing, holding together, and/or wrapping.

As used herein, the term “attaching device” is defined as means of removably retaining, securing, holding together, and/or wrapping multiple objects together. Examples of attaching devices include but are not limited to buckles, clamps, clasps, fasteners, and harnesses.

As used herein, the term “quick snap attaching device” means a type of attaching device similar to a buckle.

As used herein, the term “connection tube” means a hollow, expandable, and/or collapsible cylindrical body used for securing and/or connecting a piece of eyewear to the present invention.

What is claimed is:

1. An eyewear retention system with attaching device comprising:
at least two straps or panels;
each of the at least two straps or panels having a first end and second end; and
the first end and/or second end of each of the at least two straps or panels having at least one attaching device.

2. The eyewear retention system with attaching device of claim 1 wherein at least one of the at least one attaching device on each of the at least two straps or panels is at least one of a complete quick snap attaching device, the male portion of a quick snap attaching device, and/or the female portion of a quick snap attaching device.

3. The eyewear retention system with attaching device of claim 1 wherein at least one of the at least one attaching device is at least one connection tube.

4. The eyewear retention system with attaching device of claim 1 wherein at least one of the at least two straps or panels is elongated.

5. The eyewear retention system with attaching device of claim 3 wherein the at least one connection tube is elongated.

6. The eyewear retention system with attaching device of claim 1 wherein the at least two straps or panels are fabricated in part or in whole from at least one of plastic, fabric, rubber, elastic, nylon, metal, hemp, animal skin and/or natural and/or synthetic rubber-like material.

7. The eyewear retention system with attaching device of claim 3 wherein the at least one connection tube has a first end and second end.

8. The eyewear retention system with attaching device of claim 7 wherein the first end and/or second end of the at least one connection tube connects and/or attaches to the first end and/or second end of at least one of the at least two straps or panels.

9. The eyewear retention system with attaching device of claim 7 wherein the first end and/or second end of the at least one connection tube connects and/or attaches to a piece of eyewear.

10. The eyewear retention system with attaching device of claim 1 wherein each of the at least one attaching device is fabricated in part or in whole from at least one of plastic, fabric, rubber, elastic, nylon, metal, hemp, animal skin and/or natural and/or synthetic rubber-like material.

11. The eyewear retention system with attaching device of claim 1 wherein the eyewear retention system with attaching device retains eyewear to the head, neck, or other body part of the wearer at a desired level of retention.

12. The method for use of the eyewear retention system with attaching device is comprised of the following steps:
if (i) one of the attaching devices on one of the at least two straps or panels is a male portion of the quick snap attaching device, and one of the attaching devices on the other one of the at least two straps or panels is a female portion of the quick snap attaching device; (ii) said male portion of the quick snap attaching device and female portion of the quick snap attaching device of the eyewear retention system with attaching device are not attached or connected together prior to User's use; and (iii) User does not desire to connect said male portion of the quick snap attaching device and female portion of the quick snap attaching device prior to placing the eyewear retention system with attaching device around the User:
User takes control of a piece of eyewear, such as eyeglasses or sunglasses;
User takes control of the earpieces of said piece of eyewear;
User unfolds and/or extends the earpieces of said piece of eyewear;
User takes control of one of the connection tubes of the eyewear retention system with attaching device and takes control of one earpiece of said piece of eyewear;
User slides said earpiece into said connection tube;
User takes control of the other connection tube of the eyewear retention system with attaching device and takes control of the other earpiece of said piece of eyewear;
User slides said earpiece into said connection tube;
User places said piece of eyewear in front of User's face and/or neck;
User places one of the at least two straps or panels on one side of the User's face, head, and/or neck;
User places the other one of the at least two straps or panels on the other side of the User's face, head, and/or neck; and
User connects the male portion of the quick snap attaching device and the female portion of the quick snap attaching device together behind User's neck/head; or
if (i) one of the attaching devices on one of the at least two straps or panels is a male portion of the quick snap attaching device, and one of the attaching devices on the other one of the at least two straps or panels is a female portion of the quick snap attaching device; (ii) said male portion of the quick snap attaching device and female portion of the quick snap attaching device of the eyewear retention system with attaching device are not attached or connected together prior to User's use; and (iii) User desires to have said male portion of the quick snap attaching device and female portion of the quick snap attaching device connected prior to the eyewear retention system and attaching device around the User:
User takes control of a piece of eyewear, such as eyeglasses or sunglasses;
User takes control of the earpieces of said piece of eyewear;
User unfolds and/or extends the earpieces of said piece of eyewear;
User takes control of one of the connection tubes of the eyewear retention system with attaching device and takes control of one earpiece of said piece of eyewear;
User slides said earpiece into said connection tube;
User takes control of the other connection tube of the eyewear retention system with attaching device and takes control of the other earpiece said piece of eyewear;
User slides said earpiece into said connection tube;
User takes control of the male portion of the quick snap attaching device and the female portion of the quick snap attaching device;
User attaches and/or connects the male portion of the quick snap attaching device and the female portion of the quick snap attaching device together; and
User places said piece of eyewear and the eyewear retention system with attaching device over User's head in a manner that allows User's head to slide through the space created between said piece of eyewear and the eyewear retention system with attaching device; or
if (i) one of the attaching devices on one of the at least two straps or panels is a male portion of the quick snap attaching device, and one of the attaching devices on the other one of the at least two straps or panels is a female portion of the quick snap attaching device; (ii) said male portion of the quick snap attaching device and female portion of the quick snap attaching device of the eyewear retention system with attaching device are attached or connected together prior to User's use; and (iii) User does not desire to connect said male portion of the quick snap attaching device and female portion of the quick snap attaching device prior to placing the eyewear retention system with attaching device around the User:
User takes control of a piece of a piece eyewear, such as eyeglasses or sunglasses;
User takes control of the earpieces of said piece of eyewear;
User unfolds and/or extends the earpieces of said piece of eyewear;
User takes control of one of the connection tubes of the eyewear retention system with attaching device and takes control of one earpiece of said piece of eyewear;
User slides said earpiece into said connection tube;
User takes control of the other connection tube of the eyewear retention system with attaching device and takes control of the other earpiece of said piece of eyewear;
User slides said earpiece into said connection tube;
User takes control of the male portion of the quick snap attaching device and the female portion of the quick snap attaching device;
User disconnects the male portion of the quick snap attaching device from the female portion of the quick snap attaching device;
User places said piece of eyewear in front of the User's face and/or neck;
User places one of the at least two straps or panels on one side of the User's face, head, and/or neck;
User places the other one of the at least two straps or panels on the other side of the User's face, head, and/or neck; and
User connects the male portion of the quick snap attaching device and the female portion of the quick snap attaching device together behind User's neck/head; and/or
if (i) one of the attaching devices on one of the at least two straps or panels is a male portion of the quick snap attaching device, and one of the attaching devices on the other one of the at least two straps or panels is a female portion of the quick snap attaching device; (ii) said male portion of the quick snap attaching device and female portion of the quick snap attaching device of the eyewear retention system with attaching device are attached or connected together prior to User's use; and (iii) User desires to have said male portion of the quick snap attaching device and female portion of the quick snap attaching device connected prior to the eyewear retention system and attaching device around the User:
User takes control of a piece of eyewear, such as eyeglasses or sunglasses;
User takes control of the earpieces of said piece of eyewear;
User unfolds and/or extends the earpieces of said piece of eyewear;
User takes control of one of the connection tubes of the eyewear retention system with attaching device and takes control of one earpiece of said piece of eyewear;
User slides said earpiece into said connection tube;
User takes control of the other connection tube of the eyewear retention system with attaching device and takes control of the other earpiece of said piece of eyewear; and
User places the eyewear and eyewear retention system with attaching device over User's head in a manner that allows User's head to slide through the space created between the eyewear and the eyewear retention system with attaching device.
